(19) United States
(12) Patent Application Publication
(10) Pub. No.: US 2020/0081841 A1
(43) Pub. Date: Mar. 12, 2020

(54) CACHE ARCHITECTURE FOR COLUMN-ORIENTED DATABASE MANAGEMENT SYSTEMS

(71) Applicant: Bigstream Solutions, Inc., Mountain View, CA (US)

(72) Inventors: Balavinayagam Samynathan, Mountain View, CA (US); John David Davis, San Francisco, CA (US); Peter Robert Matheu, Palo Alto, CA (US); Christopher Ryan Both, Mountain View, CA (US); Maysam Lavasani, Los Altos, CA (US)

(73) Assignee: Bigstream Solutions, Inc., Mountain View, CA (US)

(21) Appl. No.: 16/563,778

(22) Filed: Sep. 6, 2019

Related U.S. Application Data
(60) Provisional application No. 62/728,493, filed on Sep. 7, 2018.

(51) Int. Cl. G06F 12/0862; G06F 16/22; G06F 9/30; G06F 16/25; G06F 12/0882; G06F 12/0891; G06F 16/2455; G06F 9/38

(52) U.S. Cl. CPC G06F 12/0862; G06F 16/221; G06F 9/30196; G06F 16/252; G06F 2212/1021; G06F 12/0891; G06F 16/24552; G06F 9/3877; G06F 12/0882

(57) ABSTRACT

Methods and systems are disclosed for a cache architecture for accelerating operations of a column-oriented database management system. In one example, a hardware accelerator for data stored in columnar storage format comprises at least one decoder to generate decoded data, a cache controller coupled to the at least one decoder. The cache controller comprising a store unit to store data in columnar format, cache admission policy hardware for admitting data into the store unit including a next address while a current address is being processed, and a prefetch unit for prefetching data from memory when a cache miss occurs.

### RELATED APPLICATIONS

This application claims the benefit of U.S. Provisional Application No. 62/728,493, filed on Sep. 7, 2018, the entire contents of this Provisional application is hereby incorporated by reference.

### TECHNICAL FIELD

Embodiments described herein generally relate to the field of data processing, and more particularly relates to a cache architecture for column-oriented database management systems.

### BACKGROUND

Conventionally, big data is a term for data sets that are so large or complex that traditional data processing applications are not sufficient. Challenges of large data sets include analysis, capture, data curation, search, sharing, storage, transfer, visualization, querying, updating, and information privacy.

Most systems run on a common Database Management System (DBMS) using a standard database programming language, such as Structured Query Language (SQL). Most modern DBMS implementations (Oracle, IBM, DB2, Microsoft SQL, Sybase, MySQL, Ingress, etc.) are implemented on relational databases. Typically, a DBMS has a client side where applications or users submit their queries and a server side that executes the queries. Unfortunately, general purpose CPUs are not efficient for database applications. On-chip cache of a general purpose CPU is not effective since it's relatively too small for real database workloads.

### SUMMARY

For one embodiment of the present invention, methods and systems are disclosed for a cache architecture for accelerating operations of a column-oriented database management system. In one example, a hardware accelerator for data stored in columnar storage format comprises at least one decoder to generate decoded data and a cache controller coupled to the at least one decoder. The cache controller comprising a store unit to store data in columnar format, cache admission policy hardware for admitting data into the store unit including a next address while a current address is being processed, and a prefetch unit for prefetching data from memory when a cache miss occurs.

Other features and advantages of embodiments of the present invention will be apparent from the accompanying drawings and from the detailed description that follows below.

### BRIEF DESCRIPTION OF THE DRAWINGS

FIG. 1 shows an embodiment of a block diagram of a big data system 100 for providing big data applications for a plurality of devices in accordance with one embodiment.

FIG. 2 shows an embodiment of a block diagram of a hardware accelerator having a cache prefetch unit for accelerating data operations in accordance with one embodiment.

FIG. 3 is a flow diagram illustrating a method 300 for accelerating big data operations by utilizing a hardware accelerator having a cache prefetch unit according to an embodiment of the disclosure.

FIG. 4 shows an embodiment of a block diagram of a cache controller architecture 400 for accelerating big data operations in accordance with one embodiment.

FIG. 5 shows an embodiment of a block diagram of a cache controller 500 and memory controller 590 for accelerating big data operations in accordance with one embodiment.

FIGS. 6, 7, 8, and 9 illustrate charts 600, 700, 800, and 850 that show average cache hit ratio versus cache size in accordance with one embodiment.

FIG. 10 illustrates the schematic diagram of a data processing system according to an embodiment of the present invention.

FIG. 11 illustrates the schematic diagram of a multi-layer accelerator according to an embodiment of the invention.

FIG. 12 is a diagram of a computer system including a data processing system according to an embodiment of the invention.

FIGS. 13A-13B illustrate a method 1300 for implementing a cache replacement algorithm that utilizes a cache controller according to an embodiment of the disclosure.

### DETAILED DESCRIPTION OF EMBODIMENTS

Methods, systems and apparatuses for accelerating big data operations with a cache architecture for column-oriented database management systems are described.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.

HW: Hardware.

SW: Software.

I/O: Input/Output.

DMA: Direct Memory Access.

CPU: Central Processing Unit.

FPGA: Field Programmable Gate Arrays.

CGRA: Coarse-Grain Reconfigurable Accelerators.

GPGPU: General-Purpose Graphical Processing Units.

MLWC: Many Light-weight Cores.

ASIC: Application Specific Integrated Circuit.

PCIe: Peripheral Component Interconnect express.

CDFG: Control and Data-Flow Graph.

FIFO: First In, First Out

NIC: Network Interface Card

HLS: High-Level Synthesis

KPN: Kahn Processing Networks (KPN) is a distributed model of computation (MoC) in which a group of deterministic sequential processes are communicating through unbounded FIFO channels. The process network exhibits deterministic behavior that does not depend on various computation or communication delays. A KPN can be mapped onto any accelerator (e.g., FPGA based platform) for embodiments described herein.

Dataflow analysis: An analysis performed by a compiler on the CDFG of the program to determine dependencies between a write operation on a variable and the consequent operations which might be dependent on the written operation.

Accelerator: a specialized HW/SW component that is customized to run an application or a class of applications efficiently.

In-line accelerator: An accelerator for I/O-intensive applications that can send and receive data without CPU involvement. If an in-line accelerator cannot finish the processing of an input data, it passes the data to the CPU for further processing.

Bailout: The process of transitioning the computation associated with an input from an in-line accelerator to a general purpose instruction-based processor (i.e. general purpose core).

Continuation: A kind of bailout that causes the CPU to continue the execution of an input data on an accelerator right after the bailout point.

Rollback: A kind of bailout that causes the CPU to restart the execution of an input data on an accelerator from the beginning or some other known location with related recovery data like a checkpoint.

Gorilla++: A programming model and language with both dataflow and shared-memory constructs as well as a toolset that generates HW/SW from a Gorilla++ description.

GDF: Gorilla dataflow (the execution model of Gorilla++).

GDF node: A building block of a GDF design that receives an input, may apply a computation kernel on the input, and generates corresponding outputs. A GDF design consists of multiple GDF nodes. A GDF node may be realized as a hardware module or a software thread or a hybrid component. Multiple nodes may be realized on the same virtualized hardware module or on a same virtualized software thread.

Engine: A special kind of component such as GDF that contains computation.

Infrastructure component: Memory, synchronization, and communication components.

Computation kernel: The computation that is applied to all input data elements in an engine.

Data state: A set of memory elements that contains the current state of computation in a Gorilla program.

Control State: A pointer to the current state in a state machine, stage in a pipeline, or instruction in a program associated to an engine.

Dataflow token: Components input/output data elements.

Kernel operation: An atomic unit of computation in a kernel. There might not be a one to one mapping between kernel operations and the corresponding realizations as states in a state machine, stages in a pipeline, or instructions running on a general purpose instruction-based processor.

Accelerators can be used for many big data systems that are built from a pipeline of subsystems including data collection and logging layers, a Messaging layer, a Data ingestion layer, a Data enrichment layer, a Data store layer, and an Intelligent extraction layer. Usually data collection and logging layer are done on many distributed nodes. Messaging layers are also distributed. However, ingestion, enrichment, storing, and intelligent extraction happen at the central or semi-central systems. In many cases, ingestions and enrichments need a significant amount of data processing. However, large quantities of data need to be transferred from event producers, distributed data collection and logging layers and messaging layers to the central systems for data processing.

Examples of data collection and logging layers are web servers that are recording website visits by a plurality of users. Other examples include sensors that record a measurement (e.g., temperature, pressure) or security devices that record special packet transfer events. Examples of a messaging layer include a simple copying of the logs, or using more sophisticated messaging systems (e.g., Kafka, Nifi). Examples of ingestion layers include extract, transform, load (ETL) tools that refer to a process in a database usage and particularly in data warehousing. These ETL tools extract data from data sources, transform the data for storing in a proper format or structure for the purposes of querying and analysis, and load the data into a final target (e.g., database, data store, data warehouse). An example of a data enrichment layer is adding geographical information or user data through databases or key value stores. A data store layer can be a simple file system or a database. An intelligent extraction layer usually uses machine learning algorithms to learn from past behavior to predict future behavior.

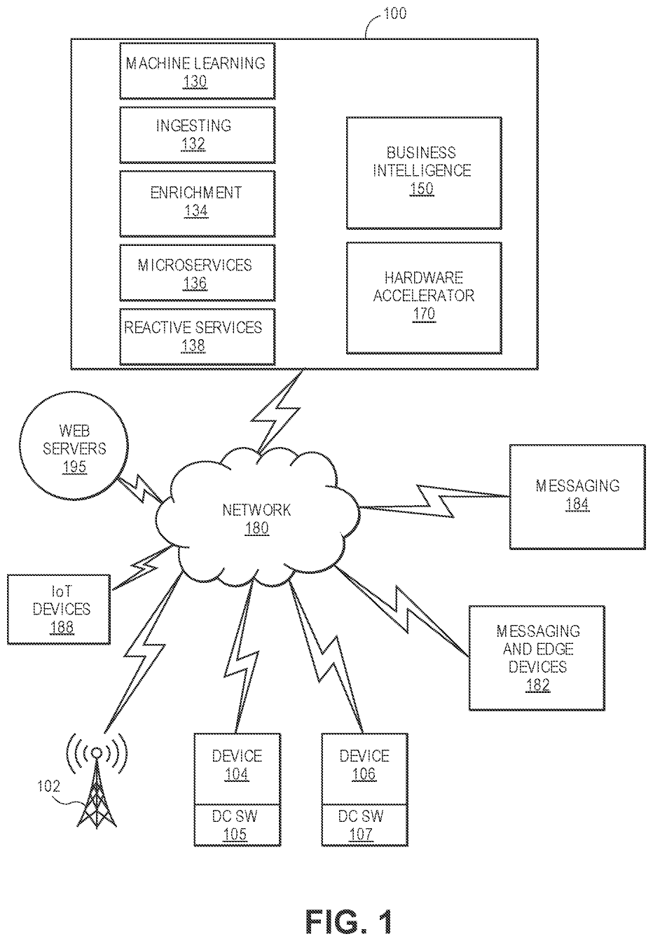

FIG. 1 shows an embodiment of a block diagram of a big data system 100 for providing big data applications for a plurality of devices in accordance with one embodiment. The big data system 100 includes machine learning modules 130, ingestion layer 132, enrichment layer 134, microservices 136 (e.g., microservice architecture), reactive services 138, and business intelligence layer 150. In one example, a microservice architecture is a method of developing software applications as a suite of independently deployable, small, modular services. Each service has a unique process and communicates through a lightweight mechanism. The system 100 provides big data services by collecting data from messaging systems 182 and edge devices, messaging systems 184, web servers 195, communication modules 102, internet of things (IoT) devices 186, and devices 104 and 106 (e.g., source device, client device, mobile phone, tablet device, laptop, computer, connected or hybrid television (TV), IPTV, Internet TV, Web TV, smart TV, satellite device, satellite TV, automobile, airplane, etc.). Each device may include a respective big data application 105, 107 (e.g., a data collecting software layer) for collecting any type of data that is associated with the device (e.g., user data, device type, network connection, display orientation, volume setting, language preference, location, web browsing data, transaction type, purchase data, etc.). The system 100, messaging systems and edge devices 182, messaging systems 184, web servers 195, communication modules 102, internet of things (IoT) devices 186, and devices 104 and 106 communicate via a network 180 (e.g., Internet, wide area network, cellular, WiFi, WiMax, satellite, etc.).

Columnar storage formats like Parquet or optimized row columnar (ORC) can achieve higher compression rates if dictionary decoding is preceded by Run Length Encoding (RLE) or Bit-packed (BP) encoding. Apache Parquet is an example of a columnar storage format available to any project in a Hadoop ecosystem. Parquet is built for compression and encoding schemes. Apache optimized row columnar (ORC) is another example of a columnar storage format.

Big data applications are often stored in columnar formats. When a hardware accelerator is parsing columnar formatted file, hardware accelerator processes multiple columns at once, which means contention on a shared resource (e.g., a double data rate (DDR) Bus). A bandwidth needed for processing multiple columns at once can exceed a bandwidth of the shared resource (e.g., DDR bus).

Typical On-board DDRs may have bandwidth ranging from 1 GB/s to 4 GB/s. In one example, each column in the accelerator needs a bandwidth of 1 GB/s to 2 GB/s. Thus, for a given file with 10 columns, this amount of bandwidth needed could easily exceed the available DDR bandwidth. Hence, the present design includes an on-board cache architecture and prefetch unit to improve performance for a hardware accelerator 170. In software based columnar format parsers, it is critical to improve the performance of address decoding.

The present design includes a unique cache architecture that improves performance for data stored in any columnar format (e.g., Parquet, ORC formats) that have key value pair encoded data (e.g., dictionary encoded data, Hoffman encoded data) with or without Run Length Encoding (RLE) or Bit-packed (BP) encoding as well. The present design also has a software solution such that if a data distribution for a big data application is available then it is loaded in a software scratch pad memory. A hardware scratch pad memory is a high-speed internal memory used for temporary storage of calculations and data.

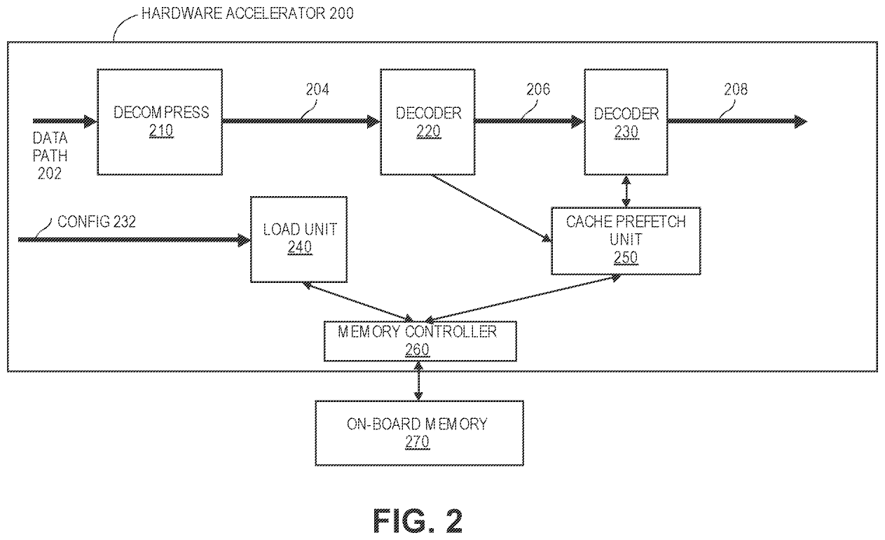

FIG. 2 shows an embodiment of a block diagram of a hardware accelerator having a cache prefetch unit for accelerating data operations in accordance with one embodiment. A column, typically stored in binary format, can be fetched by a hardware accelerator 200 that includes a decompress unit 210 (e.g., GZIP decoder, SNAPPY decoder) that receives data via data path 202 and decompresses the data if the input data is compressed. Then, decompressed data 204 is decoded with decoder 220. This decoder 220 may perform at least one of RLE and Bit-Packed decoding of data. After the RLE/BP decoding to generate data 206, a decoder 230 further decodes data 206 to generate data 208. In one example, the decoder 230 performs dictionary lookup. In another example, the decoder 230 is a key value decoder. The decoder 230 reads data from cache prefetch unit 250 if available in the cache prefetch unit 250. Otherwise, data is read from a controller 260 (e.g., cache controller, DDR controller) that can access on-board DDR memory 270. A load unit 240 (e.g., load dictionary) receives configuration data 232 for dictionary lookup operations. The load unit 240 may load data distributions into a column store unit of the controller.

In one example, a decoder 220 receives decompressed data and performs RLE to generate address values and count (e.g., (1, 3), (2, 4)). For (1, 3), the address value 1 is repeated 3 times. The decoder 230 receives the address values and count to determine a decoded value or string. For example, the key value 1 may represent a “pet” while a key value 2 may represent a “cat.”

The present design includes the cache prefetch unit to improve performance for a hardware accelerator. In an example, for line-rate processing the present design provides a cache hit rate of at least 95%.

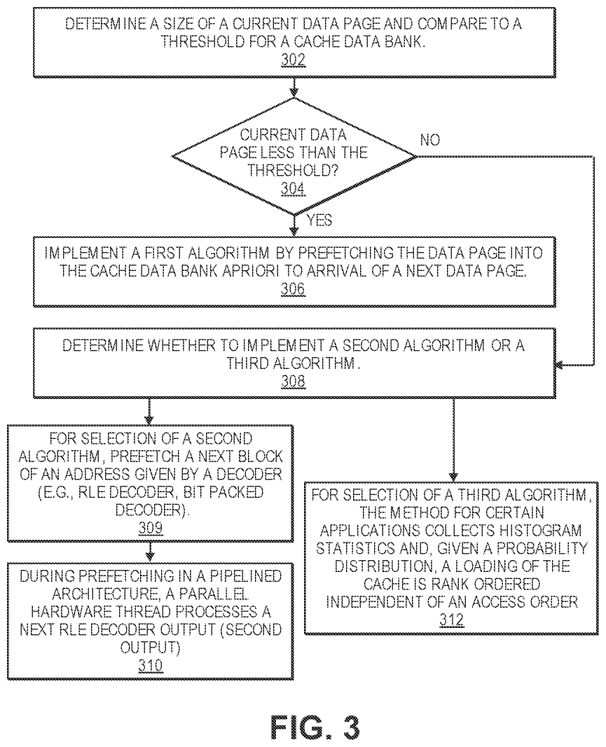

FIG. 3 is a flow diagram illustrating a method 300 for accelerating big data operations by utilizing a hardware accelerator having a cache prefetch unit according to an embodiment of the disclosure. Although the operations in the method 300 are shown in a particular order, the order of the actions can be modified. Thus, the illustrated embodiments can be performed in a different order, and some operations may be performed in parallel. Some of the operations listed in FIG. 3 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of method 300 may be executed by a compiler component, a data processing system, a machine, a server, a web appliance, a centralized system, a distributed node, or any system, which includes an accelerator. The accelerator may include hardware (circuitry, dedicated logic, etc.), software (such as is run on a general purpose computer system or a dedicated machine or a device), or a combination of both.

At operation 302, the method includes determining a size of a current data page (e.g., dictionary page) and comparing to a threshold for a cache data bank. At operation 304, the method determines whether the size of the current data page is less than the threshold. If so, then the method at operation 306 proceeds to implement a first algorithm by prefetching the data page into the cache data bank apriori to arrival of a next data page.

If not, at operation 308, the method determines whether to implement a second algorithm or a third algorithm. For selection of a second algorithm, the method at operation 309 prefetches a next block of an address given by a decoder (e.g., RLE decoder, bit-packed decoder). As an example, the RLE decoder generates a first output (e.g., (4, 10)) with 4 being an address and 10 is a repeat count. The decoder 230 (e.g., dictionary lookup) will read cache for the address 4. While this operation is happening in a pipelined architecture, a parallel hardware thread processes a next RLE decoder output (second output) at operation 310, which might be (5, 20) where the contents of address 5 are repeated 20 times. If the encoding is RLE successively then, this second algorithm may have an initial cache miss, but due to repetition with key values of repeat count, the subsequent key values can be prefetched and this ensures a reduction in cache misses based on a choice of cache eviction policy. For contents with short string data (e.g., pet, cat), less time is needed for checking for the contents in a cache while contents with long string data will need more time for obtaining the content from cache due to multiple reads from cache for each long string. In one example, an output is an indirection address for software to use to populate a final string. The output of the decoder is then simply a size plus position field of the string, but not the string itself. The string is handled by software to finish filling out the column strings. If the data encoding is bit-packed or a hybrid of Bit-Packed and RLE, then cache misses can happen (e.g., only up to 3 repeated values for bit-packed) for future output values due to less time needed for processing a first output. Bit-packed encoding is typically utilized for distinctive integers or numbers with minimal repetitive values.

For selection of a third algorithm, the method for certain applications provides the ability to collect histogram statistics. In such cases, given a probability distribution, a loading of the cache is rank ordered independent of an access order at operation 312. In other words, a highest probability distribution has a highest ranking while lower probability distributions have a lower ranking for the cache. This loading could be for a scratch pad and manages a replacement policy of the cache. Alternatively, the loading can be implemented in pure software as well. Units like Spark SQL support histogram generation of tables from an application level. In one example, in spark Use a spark.sql.statistics.histogram.enabled configuration property to enable column (equi-height) histograms that can provide better estimation accuracy but cause an extra table scan.

The method 300 can also implement a fourth algorithm if a column in the file is sorted (e.g., integers numbers sorted by value), then prefetcher is conveyed the sorted order, facilitating a simpler static prefetch mechanism (e.g., to prefetch a next sorted value). This implementation will have zero cache misses.

For algorithms 2 and 3, if the cache unit includes a programmable prefetcher in any form of an accelerator (e.g., FPGA or ASIC), then the programmable prefetcher can be loaded with the rank ordered elements of the histogram or the next values from RLE decoder so as to get better cache hit rate.

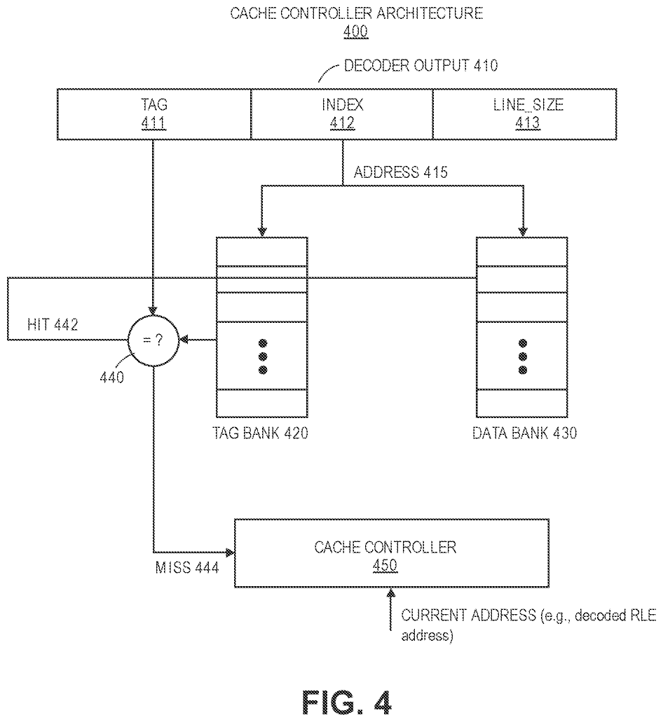

FIG. 4 shows an embodiment of a block diagram of a cache controller architecture 400 for accelerating big data operations in accordance with one embodiment. A cache controller architecture 400 (e.g., cache prefetch unit 250) includes a decoded output 410 having a tag 411, an index 412, and a line size 413. The cache controller architecture 400 includes logic 440 for determining whether a tag of decoded output matches a tag of the tag bank 420. If the logic 440 determines a cache hit 442, then the data from the data bank 430 for the cache hit can be obtained for a decoder (e.g., decoder 230). Otherwise, if the logic 440 determines a cache miss 444, then the desired tag is sent to the cache controller 450 to obtain this tag and corresponding data from memory (e.g., memory 270).

There is a synergy between a cache controller and a RLE decoder that is a key contribution of this enhanced cache controller. A cache controller that is designed specifically for columnar data formats with a low degree of data entropy (or a high degree of repetition) can make use of the synergy by pre-fetching data leading to a higher probability of cache hit. Data entropy can be considered as a measure of the number of unique values in a given set of data where a low entropy would correspond to a low number of unique values.

A tag 411 contains (part of) the address 415 of the actual data fetched from a main memory. The index 412 indicates which cache row (e.g., cache line) of the cache data bank that the data has been stored.

In a direct mapped cache structure, the cache is organized into multiple sets with a single cache line per set. Based on the address of a memory block, the address can only occupy a single cache line. The cache can be framed as a (n*1) column matrix.

In a fully associative cache, the cache is organized into a single cache set with multiple cache lines. A memory block can occupy any of the cache lines. The cache organization can be framed as (1*m) row matrix. Measuring or predicting the probability of a cache miss can be accomplished by a variety of methods including the following:

i. using the frequency of a value in a range or a histogram count of the RLE data being processed;

ii. using the repetition count property of RLE data where a low count likely results in a cache miss or vice-versa.

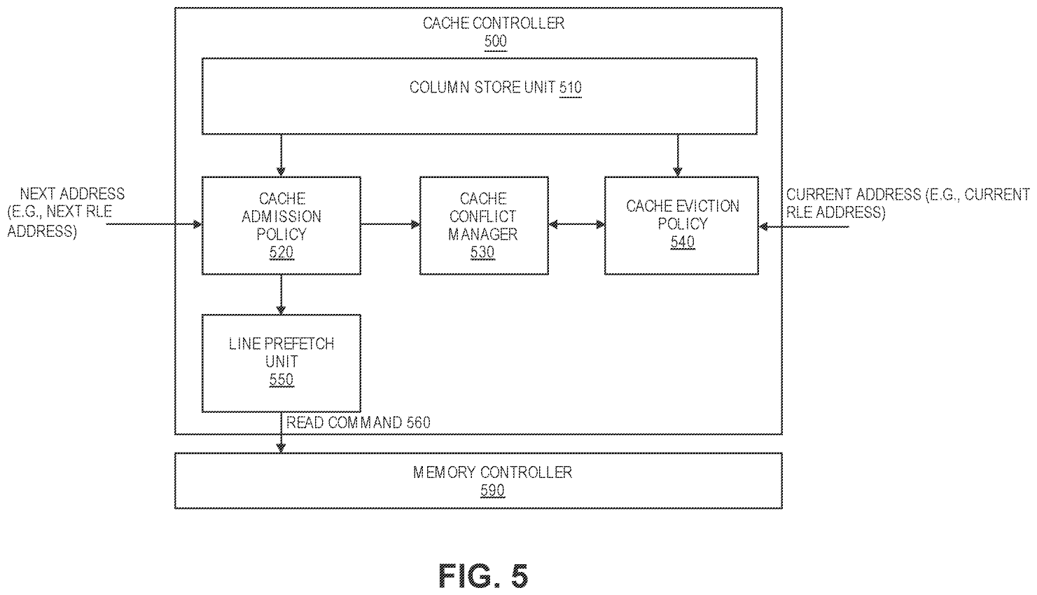

FIG. 5 shows an embodiment of a block diagram of a cache controller 500 and memory controller 590 for accelerating big data operations in accordance with one embodiment. A cache controller 500 includes a column store unit 510 (e.g., column histogram store unit) for storing data, histograms, etc. The cache controller 500 includes cache admission policy hardware 520 for admitting data (e.g., next RLE address while current RLE is being processed) into the store unit 510, cache conflict manager hardware 530 for resolving any address conflicts within the cache controller (e.g., any conflict (e.g., cache line conflict) between address being processed or address stored in cache and current prefetch address being prefetched from memory), and cache eviction policy hardware 540 for evicting data from the store unit (e.g., evict rarely used data), and line prefetch unit 550 to issue a read command 560 for prefetching data from the memory controller when a cache miss occurs.

In one example, a cache conflict manager hardware 530 detects a tag 3, index 1, and line 0 entry in cache. A prefetched data has a tag 4, index 1, and line 0. The cache conflict manager hardware 530 detects a conflict with index 1 and determines whether to evict the tag 3, index 1, and line 0 entry in cache.

In one embodiment, an alternate cache replacement algorithm does a cache check for a next-in-line address only when there is a cache miss in the cache controller. When a cache-miss occurs, the overhead for a memory access via the memory controller becomes a sunk cost. Thus, this next cache check is pipelined in parallel with the memory access for the current cache miss.

In another embodiment, an alternate cache replacement algorithm exploits the RLE repetition count and can perform different operations based on a repetition count.

For a first example, when a repetition count is low, this algorithm performs a cache check and prefetches if needed. Alternatively for a second example, this algorithm skips prefetch and checks for large repetition counts. The overhead of off-chip memory as a fraction of time spent is reduced when the repetition count is high. If this second example includes 48 output values, 8 values per flit (flow control unit), and 1 flit per clock cycle, then 240 values can be used as a threshold for a 30 clock cycle latency to off-chip memory. In other words, if the values exceed the threshold, then the algorithm does access off-chip memory due to greater processing time needed for high repetition count. For a third example, skipping the cache check and prefetch can be beneficial when off-chip memory is a shared resource in the hardware architecture and thus avoids or reduces contention for accessing the off-chip memory.

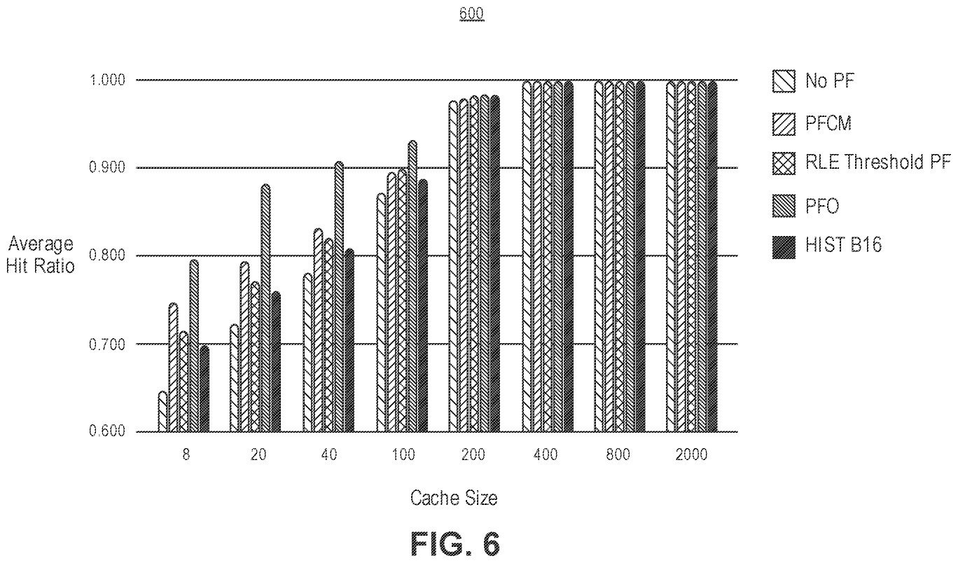

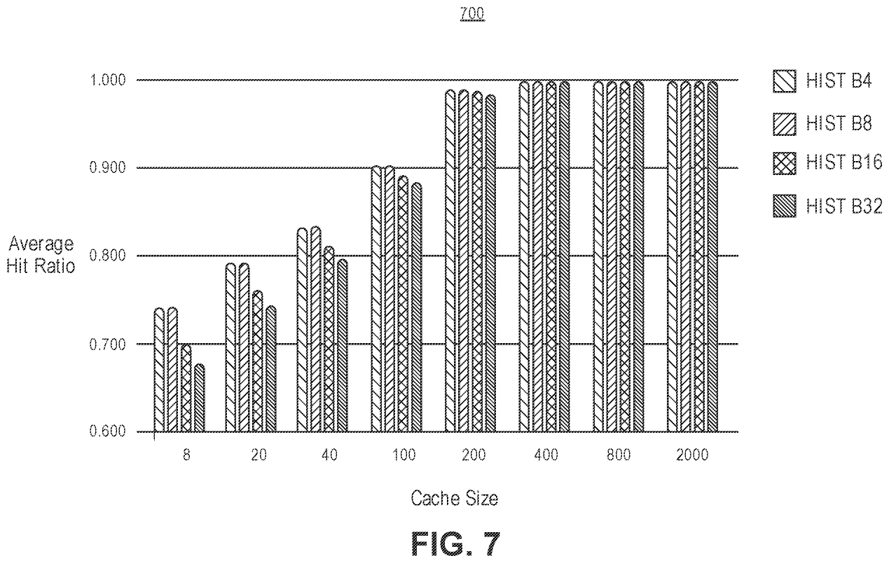

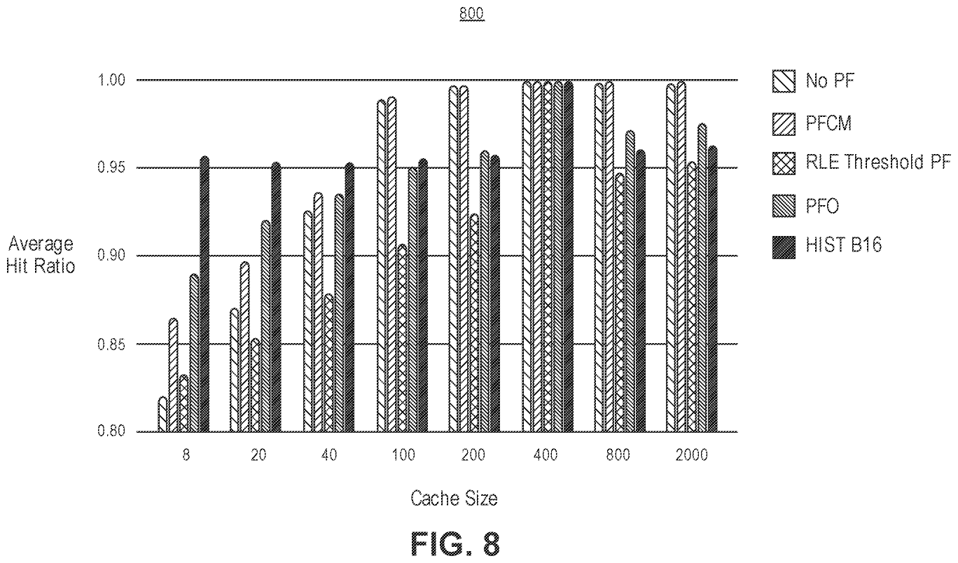

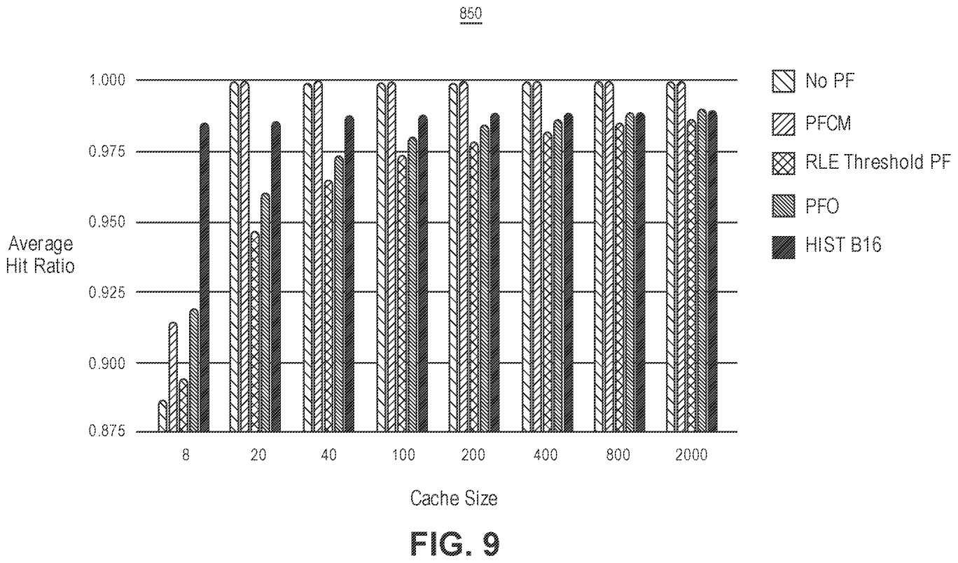

All data presented in FIGS. 6-9 is from TPC-DS benchmarks. The cache was modeled in Python. FIGS. 6, 7, 8, and 9 illustrate charts 600, 700, 800, and 850 that show average cache hit ratio versus cache size in accordance with one embodiment. The chart 600 compares the average cache hit ratio defined as the number of cache hits divided by the total number of lookup accesses for different algorithms including no prefetch (conventional), prefetch on a cache miss (PFCM), RLE threshold prefetch, prefetch ordered (PFO), and HIST B16. This comparison is done using a direct memory map (Direct MM) based cache replacement algorithm for columnar double data. The DirectMM is a relatively simple and straightforward cache replacement algorithm to implement in hardware (fully autonomous from software).

The chart 700 compares the average cache hit ratio defined as the number of cache hits divided by the total number of lookup accesses for different algorithms including HIST B4, HIST B8, HIST B16, and B32. This comparison is done using a direct memory map (Direct MM) based cache replacement algorithm for columnar double data. The DirectMM is a relatively simple and straightforward cache replacement algorithm to implement in hardware (fully autonomous from software).

The chart 800 compares the average cache hit ratio defined as the number of cache hits divided by the total number of lookup accesses for different algorithms including no prefetch (conventional), prefetch on a cache miss (PFCM), RLE threshold prefetch, prefetch ordered (PFO), and HIST B16. This comparison is done using a direct memory map (Direct MM) based cache replacement algorithm for columnar integer data. The DirectMM is a relatively simple and straightforward cache replacement algorithm to implement in hardware (fully autonomous from software).

The chart 850 compares the average cache hit ratio defined as the number of cache hits divided by the total number of lookup accesses for different algorithms including no prefetch (conventional), prefetch on a cache miss (PFCM), RLE threshold prefetch, prefetch ordered (PFO), and HIST B16. This comparison is done using a direct memory map (Direct MM) based cache replacement algorithm for columnar string data.

As expected and illustrated in FIGS. 6-9, increasing the size of the cache increases the cache hit ratio where a higher cache hit ratio results is better. Eventually, the cache hit ratio asymptotically approaches 1.000 as the size of the cache increases. A cache check refers to the practice of preemptively checking the cache for an entry of the next lookup address; whenever this cache check fails, the algorithm then updates the cache with the next lookup address value.

Introducing a cache check for the next lookup address when there is a cache miss and subsequently updating the cache before the next lookup improves the cache hit ratio (label PFCM in FIG. 6). If the memory where the lookup table is stored is a shared resource, then reducing the number of prefetch accesses reduces the possibility of contention for a shared resource. A third bar for each cache size uses an RLE repeat count as a threshold to determine whether to perform a cache check. When the repeat count is large, more time is needed to replicate all the data and so the memory access time as a fraction of total time is lower.

As expected, using an RLE threshold to gate the number of memory accesses yields a cache hit ratio between runs with and without a prefetch algorithm for sufficiently small cache sizes.

Note that when the cache size is large enough, the cache hit ratio remains high. This single chart provides insight to how a small cache's performance can be improved using a simple cache check and prefetch algorithm.

For prefetch on a cache miss algorithm (PFCM), whenever there is a cache miss, then there is a penalty for a memory access. So, pipeline the operations by performing the ‘next-in-line’ address for a cache check plus prefetch, if needed.

For RLE Threshold based PF algorithm, this analysis uses a random number (currently, a random integer between 1 and 100). In one example, the threshold is set to be 20 (same setting as the cost for a memory access). This threshold may be arbitrary; as threshold increases, the algorithm should improve. The motivation here is that when the RLE repeat count is high, an output engine will spend more time replicating the value. The present design beneficially uses that time by performing a cache check for the next-in-line address and prefetching those contents, when needed.

A PFO algorithm prefetches a next address based on (address+cache_size−1). This PFO algorithm works best when data is sorted.

HIST B # (e.g., HIST B16) algorithm utilizes a histogram with # being the number of bins plus a static prefetch for any index that falls in the bin of highest count. This can be affected by the skew in the data.

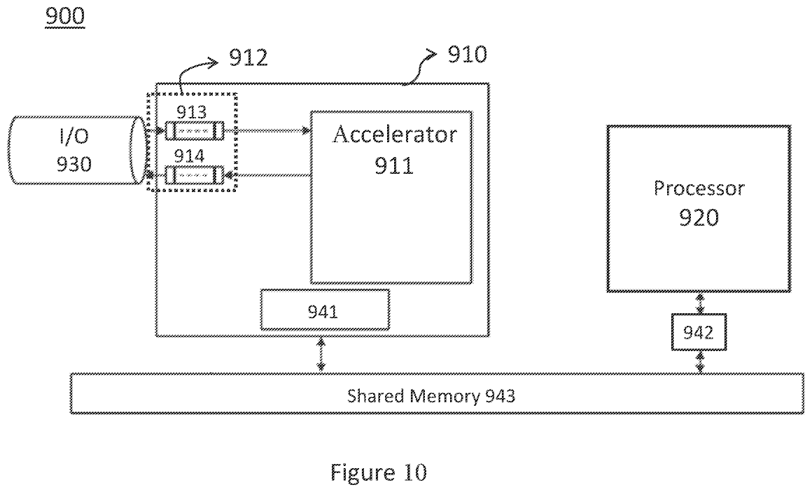

FIG. 10 illustrates the schematic diagram of data processing system 900 according to an embodiment of the present invention. Data processing system 900 includes I/O processing unit 910 and general purpose instruction-based processor 920. In an embodiment, general purpose instruction-based processor 920 may include a general purpose core or multiple general purpose cores. A general purpose core is not tied to or integrated with any particular algorithm. In an alternative embodiment, general purpose instruction-based processor 920 may be a specialized core. I/O processing unit 910 may include an accelerator 911 (e.g., in-line accelerator, offload accelerator for offloading processing from another computing resource, or both) for implementing embodiments as described herein. In-line accelerators are a special class of accelerators that may be used for I/O intensive applications. Accelerator 911 and general purpose instruction-based processor may or may not be on a same chip. Accelerator 911 is coupled to I/O interface 912. Considering the type of input interface or input data, in one embodiment, the accelerator 911 may receive any type of network packets from a network 930 and an input network interface card (NIC). In another embodiment, the accelerator maybe receiving raw images or videos from the input cameras. In an embodiment, accelerator 911 may also receive voice data from an input voice sensor device.

In an embodiment, accelerator 911 is coupled to multiple I/O interfaces (not shown in the figure). In an embodiment, input data elements are received by I/O interface 912 and the corresponding output data elements generated as the result of the system computation are sent out by I/O interface 912. In an embodiment, I/O data elements are directly passed to/from accelerator 911. In processing the input data elements, in an embodiment, accelerator 911 may be required to transfer the control to general purpose instruction-based processor 920. In an alternative embodiment, accelerator 911 completes execution without transferring the control to general purpose instruction-based processor 920. In an embodiment, accelerator 911 has a master role and general purpose instruction-based processor 920 has a slave role.

In an embodiment, accelerator 911 partially performs the computation associated with the input data elements and transfers the control to other accelerators or the main general purpose instruction-based processor in the system to complete the processing. The term “computation” as used herein may refer to any computer task processing including, but not limited to, any of arithmetic/logic operations, memory operations, I/O operations, and offloading part of the computation to other elements of the system such as general purpose instruction-based processors and accelerators. Accelerator 911 may transfer the control to general purpose instruction-based processor 920 to complete the computation. In an alternative embodiment, accelerator 911 performs the computation completely and passes the output data elements to I/O interface 912. In another embodiment, accelerator 911 does not perform any computation on the input data elements and only passes the data to general purpose instruction-based processor 920 for computation. In another embodiment, general purpose instruction-based processor 920 may have accelerator 911 to take control and completes the computation before sending the output data elements to the I/O interface 912.

In an embodiment, accelerator 911 may be implemented using any device known to be used as accelerator, including but not limited to field-programmable gate array (FPGA), Coarse-Grained Reconfigurable Architecture (CGRA), general-purpose computing on graphics processing unit (GPGPU), many light-weight cores (MLWC), network general purpose instruction-based processor, I/O general purpose instruction-based processor, and application-specific integrated circuit (ASIC). In an embodiment, I/O interface 912 may provide connectivity to other interfaces that may be used in networks, storages, cameras, or other user interface devices. I/O interface 912 may include receive first in first out (FIFO) storage 913 and transmit FIFO storage 914. FIFO storages 913 and 914 may be implemented using SRAM, flip-flops, latches or any other suitable form of storage. The input packets are fed to the accelerator through receive FIFO storage 913 and the generated packets are sent over the network by the accelerator and/or general purpose instruction-based processor through transmit FIFO storage 914.

In an embodiment, I/O processing unit 910 may be Network Interface Card (NIC). In an embodiment of the invention, accelerator 911 is part of the NIC. In an embodiment, the NIC is on the same chip as general purpose instruction-based processor 920. In an alternative embodiment, the NIC 910 is on a separate chip coupled to general purpose instruction-based processor 920. In an embodiment, the NIC-based accelerator receives an incoming packet, as input data elements through I/O interface 912, processes the packet and generates the response packet(s) without involving general purpose instruction-based processor 920. Only when accelerator 911 cannot handle the input packet by itself, the packet is transferred to general purpose instruction-based processor 920. In an embodiment, accelerator 911 communicates with other I/O interfaces, for example, storage elements through direct memory access (DMA) to retrieve data without involving general purpose instruction-based processor 920.

Accelerator 911 and the general purpose instruction-based processor 920 are coupled to shared memory 943 through private cache memories 941 and 942 respectively. In an embodiment, shared memory 943 is a coherent memory system. The coherent memory system may be implemented as shared cache. In an embodiment, the coherent memory system is implemented using multiples caches with coherency protocol in front of a higher capacity memory such as a DRAM.

In an embodiment, the transfer of data between different layers of accelerations may be done through dedicated channels directly between accelerator 911 and processor 920. In an embodiment, when the execution exits the last acceleration layer by accelerator 911, the control will be transferred to the general-purpose core 920.

Processing data by forming two paths of computations on accelerators and general purpose instruction-based processors (or multiple paths of computation when there are multiple acceleration layers) have many other applications apart from low-level network applications. For example, most emerging big-data applications in data centers have been moving toward scale-out architectures, a technology for scaling the processing power, memory capacity and bandwidth, as well as persistent storage capacity and bandwidth. These scale-out architectures are highly network-intensive. Therefore, they can benefit from acceleration. These applications, however, have a dynamic nature requiring frequent changes and modifications. Therefore, it is highly beneficial to automate the process of splitting an application into a fast-path that can be executed by an accelerator with subgraph templates and a slow-path that can be executed by a general purpose instruction-based processor as disclosed herein.

While embodiments of the invention are shown as two accelerated and general-purpose layers throughout this document, it is appreciated by one skilled in the art that the invention can be implemented to include multiple layers of computation with different levels of acceleration and generality. For example, a FPGA accelerator can backed by a many-core hardware. In an embodiment, the many-core hardware can be backed by a general purpose instruction-based processor.

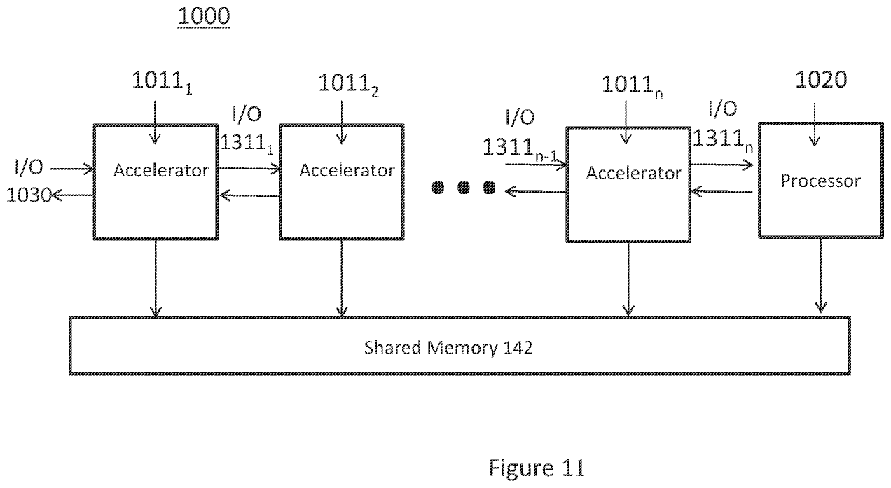

Referring to FIG. 11, in an embodiment of invention, a multi-layer system 1000 that utilizes a cache controller is formed by a first accelerator 1011₁ (e.g., in-line accelerator, offload accelerator for offloading processing from another computing resource, or both) and several other accelerators 1011ₙ (e.g., in-line accelerator, offload accelerator for offloading processing from another computing resource, or both). The multi-layer system 1000 includes several accelerators, each performing a particular level of acceleration. In such a system, execution may begin at a first layer by the first accelerator 1011₁. Then, each subsequent layer of acceleration is invoked when the execution exits the layer before it. For example, if the accelerator 1011₁ cannot finish the processing of the input data, the input data and the execution will be transferred to the next acceleration layer, accelerator 1011₂. In an embodiment, the transfer of data between different layers of accelerations may be done through dedicated channels between layers (e.g., 1311₁ to 1311ₙ). In an embodiment, when the execution exits the last acceleration layer by accelerator 1011ₙ, the control will be transferred to the general-purpose core 1020.

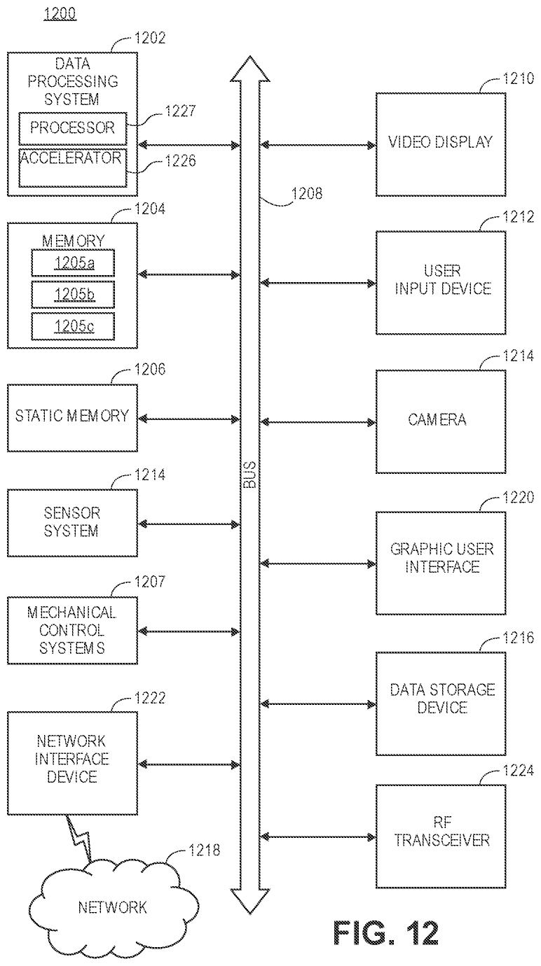

FIG. 12 is a diagram of a computer system including a data processing system that utilizes an accelerator with a cache controller according to an embodiment of the invention. Within the computer system 1200 is a set of instructions for causing the machine to perform any one or more of the methodologies discussed herein including accelerating operations of column based database management systems. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

Data processing system 1202, as disclosed above, includes a general purpose instruction-based processor 1227 and an accelerator 1226 (e.g., in-line accelerator, offload accelerator for offloading processing from another computing resource, or both). The general purpose instruction-based processor may be one or more general purpose instruction-based processors or processing devices (e.g., microprocessor, central processing unit, or the like). More particularly, data processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Data processing system 1202 is configured to implement the data processing system for performing the operations and steps discussed herein.

The exemplary computer system 1200 includes a data processing system 1202, a main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable computer-readable storage medium), which communicate with each other via a bus 1208. The storage units disclosed in computer system 1200 may be configured to implement the data storing mechanisms for performing the operations and steps discussed herein. Memory 1206 can store code and/or data for use by processor 1227 or accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and accelerator 1226 execute various software components stored in memory 1204 to perform various functions for system 1200. Furthermore, memory 1206 may store additional modules and data structures not described above.

Operating system 1205a includes various procedures, sets of instructions, software components and/or drivers for controlling and managing general system tasks and facilitates communication between various hardware and software components. A compiler is a computer program (or set of programs) that transform source code written in a programming language into another computer language (e.g., target language, object code). A communication module 1205c provides communication with other devices utilizing the network interface device 1222 or RF transceiver 1224.

The computer system 1200 may further include a network interface device 1222. In an alternative embodiment, the data processing system disclose is integrated into the network interface device 1222 as disclosed herein. The computer system 1200 also may include a video display unit 1210 (e.g., a liquid crystal display (LCD), LED, or a cathode ray tube (CRT)) connected to the computer system through a graphics port and graphics chipset, an input device 1212 (e.g., a keyboard, a mouse), a camera 1214, and a Graphic User Interface (GUI) device 1220 (e.g., a touch-screen with input & output functionality).

The computer system 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The Data Storage Device 1216 may include a machine-readable storage medium (or more specifically a computer-readable storage medium) on which is stored one or more sets of instructions embodying any one or more of the methodologies or functions described herein. Disclosed data storing mechanism may be implemented, completely or at least partially, within the main memory 1204 and/or within the data processing system 1202 by the computer system 1200, the main memory 1204 and the data processing system 1202 also constituting machine-readable storage media.

In one example, the computer system 1200 is an autonomous vehicle that may be connected (e.g., networked) to other machines or other autonomous vehicles in a LAN, WAN, or any network. The autonomous vehicle can be a distributed system that includes many computers networked within the vehicle. The autonomous vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The autonomous vehicle can operate in the capacity of a server or a client in a client-server network environment, or as a peer machine in a peer-to-peer (or distributed) network environment. The storage units disclosed in computer system 1200 may be configured to implement data storing mechanisms for performing the operations of autonomous vehicles.

The computer system 1200 also includes sensor system 1214 and mechanical control systems 1207 (e.g., motors, driving wheel control, brake control, throttle control, etc.). The processing system 1202 executes software instructions to perform different features and functionality (e.g., driving decisions) and provide a graphical user interface 1220 for an occupant of the vehicle. The processing system 1202 performs the different features and functionality for autonomous operation of the vehicle based at least partially on receiving input from the sensor system 1214 that includes laser sensors, cameras, radar, GPS, and additional sensors. The processing system 1202 may be an electronic control unit for the vehicle.

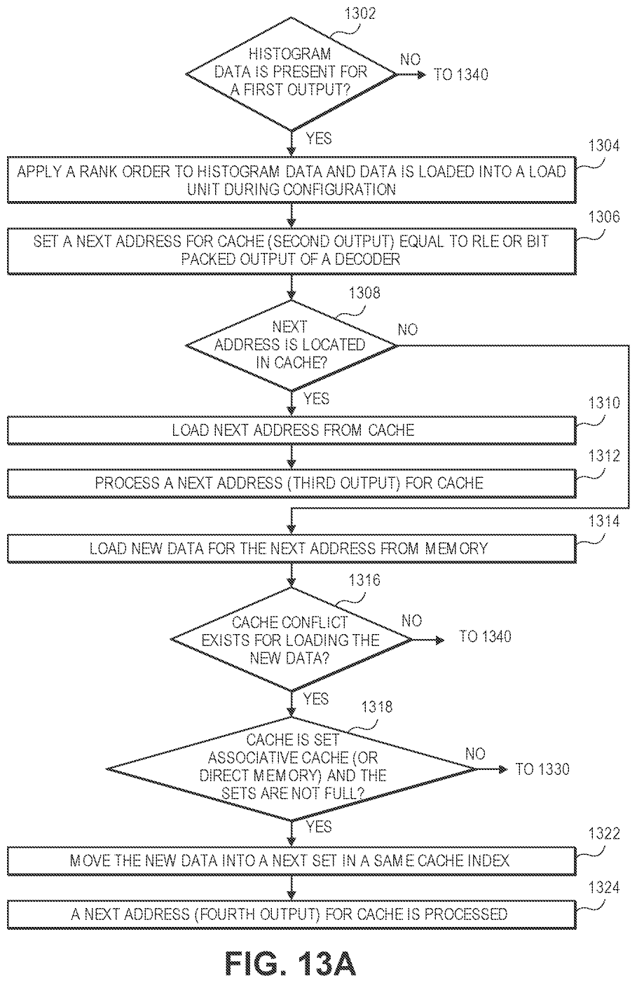

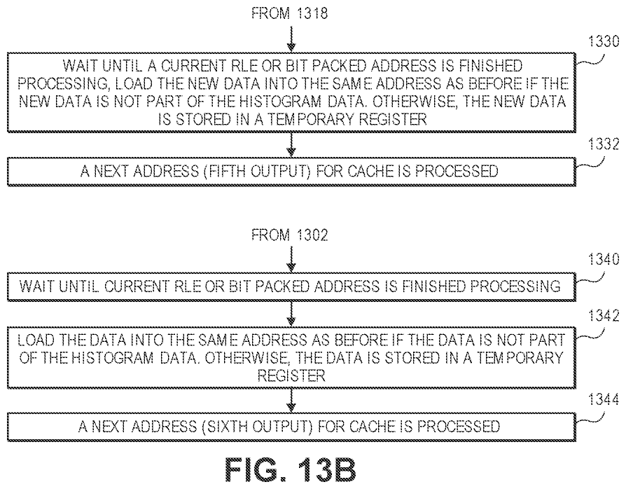

FIGS. 13A-13B illustrate a method 1300 for implementing a cache replacement algorithm that utilizes a cache controller according to an embodiment of the disclosure. Although the operations in the method 1300 are shown in a particular order, the order of the actions can be modified. Thus, the illustrated embodiments can be performed in a different order, and some operations may be performed in parallel. Some of the operations listed in FIG. 13 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of method 1300 may be executed by a cache controller, a data processing system, a machine, a server, a web appliance, a centralized system, a distributed node, or any system, which includes an accelerator. The accelerator may include hardware (circuitry, dedicated logic, etc.), software (such as is run on a general purpose computer system or a dedicated machine or a device), or a combination of both.

At operation 1302, the method includes determining whether histogram data is present for a first output of a decoder. If so, a rank order is applied to data of the histogram and data is loaded into a load unit during configuration at operation 1304. The load unit can load the data into a store unit of a cache controller. In one example, for the rank order, data values having a higher probability of being requested have a higher ranking and data values having a lower probability of being requested have a lower ranking.

At operation 1306, a next address for cache (second output) is set equal to RLE or bit-packed output of a decoder (e.g., decoder 230). At operation 1308, the method determines whether the next address is located in cache. If so, at operation 1310, the next address is loaded from cache. At operation 1312, a next address (third output) for cache is processed.

If a next address is not located in cache at operation 1308, then new data for the next address is loaded from memory at operation 1314. The cache controller determines whether a cache conflict exists for loading the new data at operation 1316. The cache controller can determine whether new data loaded into cache is in same cache line as a current cache line for determining whether a conflict exists. The method proceeds to operation 1318 if cache conflict at operation 1316. If the cache is set associative cache (or direct memory) and if the sets are not full at operation 1320, then the method moves the new data into a next set in a same cache index at operation 1322. At operation 1324, a next address (fourth output) for cache is processed.

If the sets are full at operation 1318, then the method waits until a current RLE or bit-packed address is finished processing at operation 1130. The method then loads the new data into the same address as before if the new data is not part of the histogram data. Otherwise, the new data is stored in a temporary register. At operation 1132, a next address (fifth output) for cache is processed.

If histogram data is not present for a first output at operation 1302, then the method waits until current RLE or bit-packed address is finished processing at operation 1340. If no cache conflict at operation 1316, then the method also proceeds to operation 1340. The method then loads the data into the same address as before if the data is not part of the histogram data at operation 1342. Otherwise, the data is stored in a temporary register. At operation 1344, a next address (sixth output) for cache is processed.

Metadata and column statistics can originate from tables (e.g., Hive tables). Spark SQL can be used to query data from tables. A Hive metastore service stores metadata for Hive tables and partitions in a relational database, and provides clients (including Hive) access to this information using a metastore service API. A Hive Metastore, also referred to as HCatalog is a relational database repository containing metadata about objects you create in Hive. When you create a Hive table, the table definition (column names, data types, comments, etc.) are stored in the Hive Metastore. This is automatic and simply part of the Hive architecture. The reason why the Hive Metastore is critical is because it acts as a central schema repository which can be used by other access tools like Spark and Pig. Additionally, through Hiveserver2 you can access the Hive Metastore using ODBC and JDBC connections. This opens the schema to visualization tools like PowerBi or Tableau.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A hardware accelerator for data stored in columnar storage format comprising:
at least one decoder to generate decoded data;
a cache controller coupled to the at least one decoder, the cache controller comprising,
a store unit to store data in columnar format,
cache admission policy hardware for admitting data into the store unit including a next address while a current address is being processed, and
a prefetch unit for prefetching data from memory when a cache miss occurs.

2. The hardware accelerator of claim 1, wherein the cache controller further comprising:
cache conflict manager hardware for resolving any address conflicts within the cache controller, and
cache eviction policy hardware for evicting data from the store unit.

3. The hardware accelerator of claim 1, wherein the at least one decoder to perform at least one of Run Length Encoding (RLE) and Bit-Packed decoding of data.

4. The hardware accelerator of claim 1, wherein the at least one decoder comprises a key value decoder.

5. The hardware accelerator of claim 1, wherein the at least one decoder to perform dictionary lookup.

6. The hardware accelerator of claim 1, wherein the at least one decoder reads data from the cache controller if available in the cache controller.

7. The hardware accelerator of claim 1, further comprising:
a memory controller coupled to the cache controller, wherein the at least one decoder obtains data from the memory controller if the decoded data is not available in the cache controller.

8. The hardware accelerator of claim 7, wherein the memory controller to access data stored in columnar storage format in memory.

9. The hardware accelerator of claim 1, further comprising:
a decompress unit to decompress input data from a columnar storage database;
a first decoder to decode data received from the decompress unit; and
a second decoder to receive data from the first decoder and to generate decoded data.

10. A cache controller architecture for accelerating data operations, comprising:
a tag bank;
a data bank;
logic; and
a cache controller that is designed for columnar data formats, the logic is configured to determine whether a tag of decoded output matches a tag of the tag bank.

11. The cache controller architecture of claim 10, wherein the decoded output includes a tag, an index, and a line size.

12. The cache controller architecture of claim 10, wherein if the logic determines a cache hit, then the data from the data bank for the cache hit is obtained for a decoder.

13. The cache controller architecture of claim 10, wherein if the logic determines a cache miss, then a desired tag is sent to the cache controller to obtain this tag and corresponding data from memory.

14. The cache controller architecture of claim 10, wherein the cache controller is designed for columnar data formats with a low degree of data entropy and pre-fetches data leading to a higher probability of cache hit.

15. A computer implemented method for accelerating big data operations by utilizing a hardware accelerator having a cache prefetch unit, the method comprising:
determining, with the accelerator having the cache prefetch unit, a size of a current data page and comparing to a threshold for a cache data bank;
determining whether the size of the current data page is less than the threshold; and
implementing a first algorithm by prefetching the data page into the cache data bank apriori to arrival of a next datapage when the size of the current data page is less than the threshold.

16. The computer implemented method of claim 15, further comprising:
determining whether to implement a second algorithm or a third algorithm when the size of the current data page is not less than the threshold.

17. The computer implemented method of claim 16, further comprising:
for selection of a second algorithm, prefetching a next block of an address given by a RLE decoder or bit-packed decoder.

18. The computer implemented method of claim 17, further comprising:
for selection of a third algorithm, providing an ability to collect histogram statistics, wherein given a probability distribution a loading of the cache is rank ordered independent of an access order with a highest probability distribution having a highest ranking while lower probability distributions have a lower ranking for the cache.

19. The computer implemented method of claim 15, further comprising:
implementing a fourth algorithm if a column in a file is sorted, then the cache prefetch unit is conveyed the sorted order, facilitating a simpler static prefetch mechanism.
